(19) United States
(12) Patent Application Publication
(10) Pub. No.: US 2013/0048840 A1
(43) Pub. Date: Feb. 28, 2013

(54) LIQUID OUTPUT SENSING DEVICE

(71) Applicant: TING-YU CHEN, NEW TAIPEI CITY (TW)

(72) Inventor: TING-YU CHEN, NEW TAIPEI CITY (TW)

(73) Assignee: WINLENK AUTOMATION INC., TAIPEI CITY (TW)

(21) Appl. No.: 13/569,428

(22) Filed: Aug. 8, 2012

(30) Foreign Application Priority Data
Aug. 31, 2011 (TW) 100216218

(51) Int. Cl. G01D 5/34

(52) U.S. Cl. 250/227.11

(57) ABSTRACT

A liquid output sensing device includes a body, a sensing unit, a first optical fiber, and a second optical fiber. The body is connected with a delivery structure. A liquid input port is disposed on one end of the delivery structure, and a liquid output port is disposed on another end of the delivery structure. A liquid delivery channel is disposed between the liquid input port and the liquid output port. The liquid delivery channel is connected with a first controller. The sensing unit is connected with the body, and is electrically connected with the first controller. One end of the first optical fiber is connected with the sensing unit. Another end of the first optical fiber and one end of the second optical fiber are connected with the delivery structure and near the liquid output port. Another end of the second optical fiber is connected with the sensing unit.

### FIELD OF THE INVENTION

The present invention related to a liquid output sensing device, and more particularly to a liquid output sensing device for automatically controlling the liquid output.

### BACKGROUND OF THE INVENTION

In general, the water pipeline is used to connect with the faucet for cleaning or rinsing in the indoor, outdoor or in public place. The conventional faucet includes a pipeline, a switch, and a valve structure. The valve structure is disposed within the pipeline and is connected with one end of the switch. Another end of the switch is penetrated out of the pipeline for manipulation use. The switch is rotated to open or close to control the water flow from the faucet. When the faucet is in use, the switch is usually not rotated tightly to cause the water is wasted. Thus, the water resource is wasted to increase the water cost due to the water flow cannot be controlled actually by the switch that is rotated by the artificial.

In view of above drawback in the conventional faucet, a faucet with an automatic control function is provided. As shown in FIG. 6, the difference from a conventional faucet is that the faucet with automatic control functions without using the switch to rotate to control the water flow. An IR sensor 82 is provided for disposing on the bottom of the pipeline 81A of the faucet structure 80A, such that one end of the sensing part 821 of the IR sensor 82 is facing toward the horizontal direction to sense the object 90 (for example, the human hand) which is moved to close the IR sensor 82 to automatically control the open or close of the valve structure 83 to control the water flow in the pipes channel 811 to accomplish the water conservation. However, the drawback of the faucet with automatic control function is insensitive. Because of the location of the object 90 is need to move to the level height of the sensing part 821 closely. It is too difficult to sense the object 90 by the IR sensor 82 when the level height is different between the object and the sensing part 821. In FIG. 7, another improved faucet structure 80B is provided. The IR sensor 82 is disposed on the outlet of the pipeline 81B of the improved faucet structure 80B, and one end of the sensing part 821 is facing toward the water flow out direction to increase the sensitive and the sensing range.

However, in order to accommodate the overall of the IR sensor 821 therein, the size of the head end of the pipeline 81B of the improved faucet 80B should be increased, such that the shape of the improved faucet 80B would be limited, and the space of the pipeline 80B is need to expand, and thus, the amount of the material for manufacturing the improved faucet 81B would also be increased. In addition, the improved faucet 81B is made of the cooper and the zinc alloy, and the metal material price is increased to increase the manufacturing costs of the burden.

In view of above, the present invention provides a liquid output sensing device with the function such as sensibility, the sensing part can be extended, and the overall volume of the faucet can be decreased, such that the cost can be decreased, and easy for assembling, taking apart, and replacing to increase the convenient of use.

### SUMMARY OF THE INVENTION

The objective of the present invention is to provide a liquid output sensing device with the function such as sensibility, the sensing part can be extended; the overall volume of the faucet can be decreased, so that the cost can be decreased, and easy for assembling, taking apart, and replacing to increase he convenient of use.

According to above object, the present invention provides a liquid output sensing device, which includes a body that is connected with a delivery structure. A liquid output port is disposed on one end of the delivery structure, and a liquid input port is disposed on another end of the delivery structure, such that the liquid can be flowed out toward a specified direction. A liquid delivery channel is disposed between the liquid input port and the liquid output port. The liquid delivery channel is connected with a first controller, which is used to control the liquid flow.

A sensing unit is connected with the body, and the sensing unit is electrically connected with the first controller. One end of a first optical fiber is connected with the sensing unit, and another end of the first optical fiber is connected with the delivery structure and is located near the liquid output port, in which the first optical fiber emits a signal from the sensing unit to the specified direction. One end of a second optical fiber is connected with the delivery structure and is located near the liquid output port for providing the sensing unit to receive the external signal. Because of the area of the signal emitting terminal and the signal receiving terminal of the first optical fiber and the second optical fiber are small, and the material of the first optical fiber and the second optical fiber is softness, such that the overall volume of the product can be reduced, and the design of the product with good flexibility. Thus, a liquid output sensing device with the function such as sensibility, the sensing part can be extended, and the overall volume of the faucet can be decreased, such that the cost can be decreased, and easy for assembling, taking apart, and replacing to increase the convenient of use.

### BRIEF DESCRIPTION OF THE DRAWINGS

The present invention will be apparent to those skilled in the art by reading the following description of preferred embodiments thereof with reference to the drawings, in which:

FIG. 1 shows a schematic diagram of the components of a liquid output sensing device according to the present invention disclosed herein;

FIG. 1A shows a schematic diagram of the sensing unit connected with an additional controller according to the present invention disclosed herein;

FIG. 1B shows a schematic diagram of the sensing device that is disposed separated from the additional controller of the FIG. 1 according to the present invention disclosed herein;

FIG. 2 shows a schematic diagram of a delivery structure, the sensing unit, a first optical fiber and a second optical fiber are combined in the body according to the present invention disclosed herein;

FIG. 3 is the three-dimensional schematic diagram of the first optical fiber and the second optical fiber is fixed by a fixing element according to the present invention disclosed herein;

FIG. 4 shows a schematic diagram of the delivery structure is a faucet which is implemented with the first optical fiber, the second optical fiber and the sensing unit according to the present invention disclosed herein;

FIG. 5 shows a schematic diagram of the delivery structure is a spray structure of a toilet seat which is implemented with the first optical fiber, the second optical fiber and the sensing unit according to the present invention disclosed herein:

FIG. 6 is a schematic diagram of the conventional faucet according to the prior art; and

FIG. 7 is a schematic diagram of the conventional improved faucet according to the prior art.

### DETAILED DESCRIPTION OF THE PREFERRED EMBODIMENTS

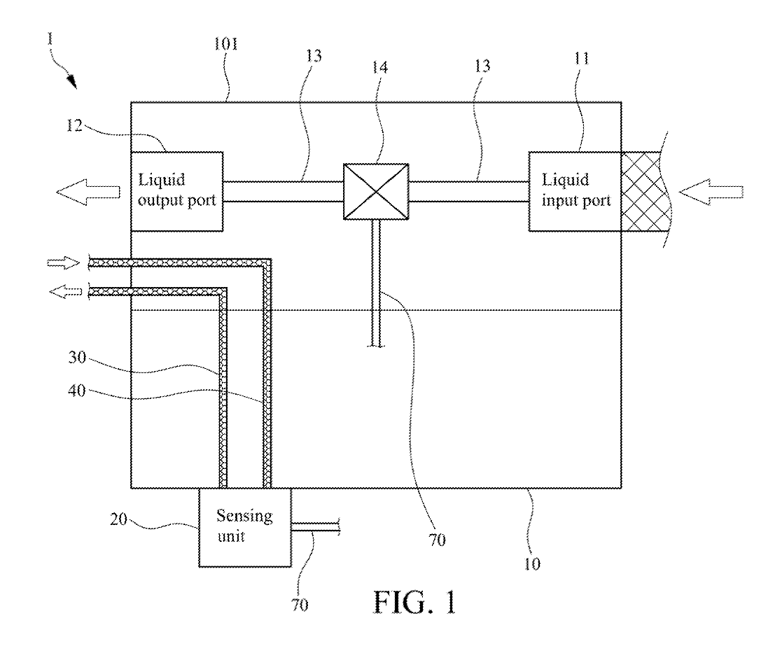

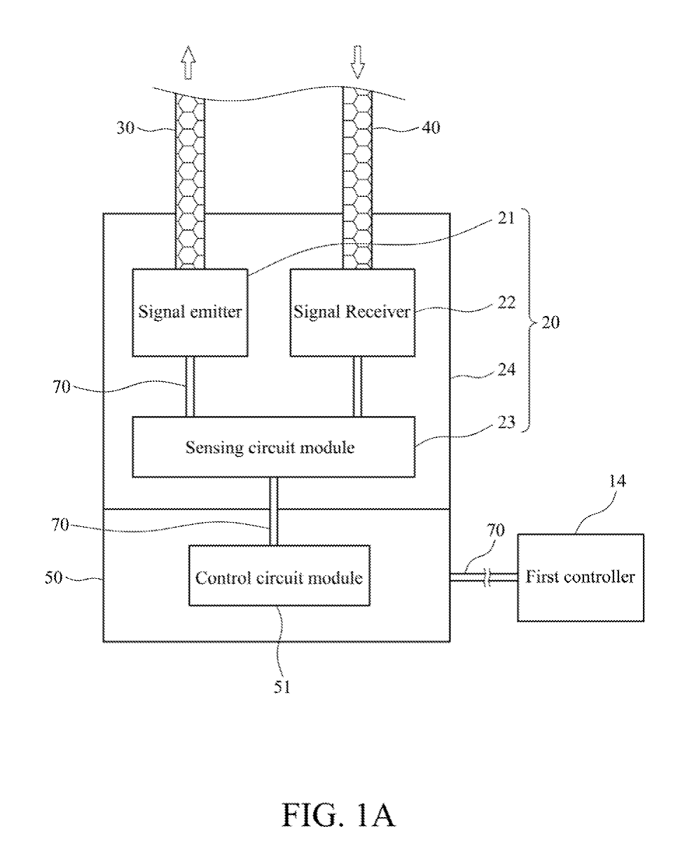

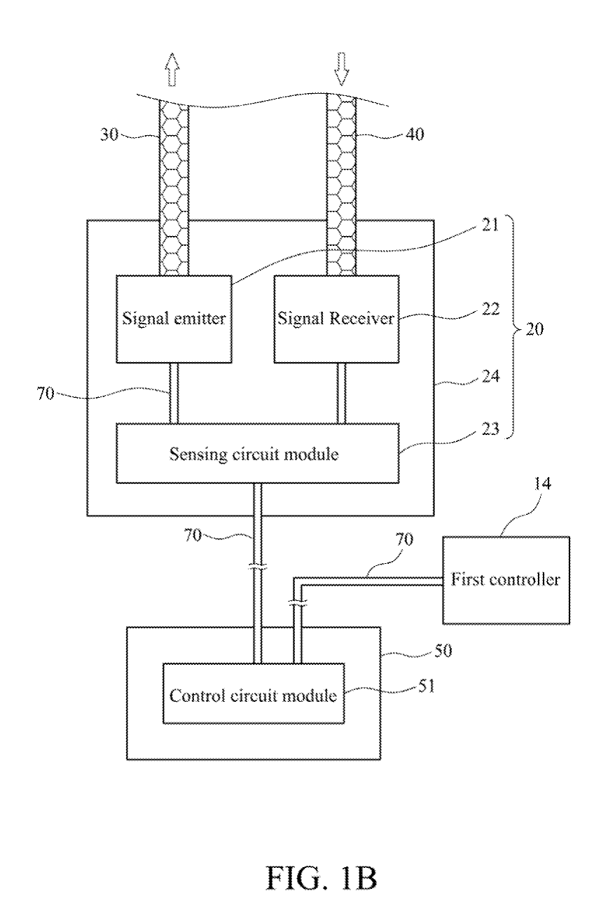

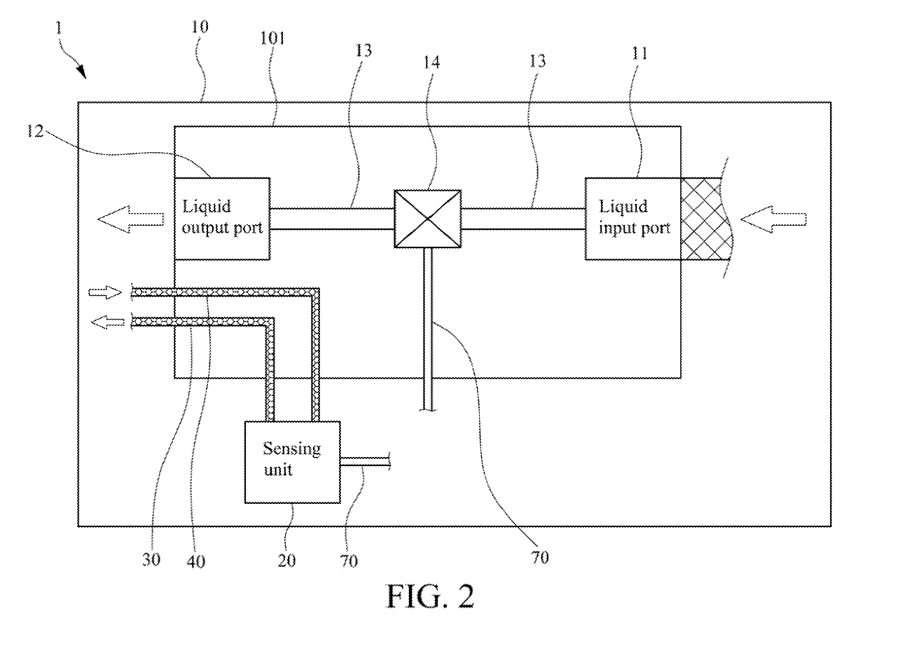

Referring to FIG. 1 through FIG. 3, shows a liquid output sensing device 1, which includes a body 10, a sensing unit, a first optical fiber 30 and a second optical fiber 40.

The body 10 is connected a delivery structure 101. A liquid input port 11 is disposed on one end of the delivery structure 101, and a liquid output port 12 is disposed on another end of the delivery structure 101, such that the liquid is flowed out toward a specified direction. A liquid delivery channel 13 is disposed between the liquid input port 11 and the liquid output port 12. The liquid delivery channel 13 is connected with a first controller 14 for controlling the liquid flow.

The sensing unit 20 is connected with the body 10. The sensing unit 20 is electrically connected with the first controller 14.

One end of the first optical fiber 30 is connected with the sensing unit 20, and another end (signal emitting terminal) of the first optical fiber 30 is connected with the delivery structure 101 and is located near the liquid output port 12, which emits the signal from the sensing unit 20 to the specified direction.

One end (signal receiving terminal) of the second optical fiber 40 is connected with the delivery structure 101 and is located near the liquid output port 12 for receiving an external signal. Another end of the second unit 20 is connected with the sensing unit 20, which is used to receive the external signal.

In one embodiment of the present invention, please refer to FIG. 1A. The sensing unit 20 includes a signal emitter 21, a signal receiver 22, a sensing circuit module 23, in which the sensing circuit module 23 is electrically connected with the signal emitter 21 and the signal receiver 22 respectively. The signal emitter 21 is disposed on one end of the sensing unit 20 and is connected with one end of the first optical fiber 30. The signal receiver 22 is parallel disposed adjacent to the signal emitter 21 and is connected with another end of the second optical fiber 40. Because of the light weight and small volume, the first optical fiber 30 and the second optical fiber 40 with oriented and the loss of the signal transmission can be reduced. The function of sensing unit 20 and the first optical fiber 30 and the second optical fiber 40 is that the sensing part can be extended, such that the remote objects can be easily sensed. In addition, the area of the signal emitting terminal of the first optical fiber 30 and the signal receiving terminal of the second optical fiber 40 is small, and the material of the first optical fiber 30 and the second optical fiber 40 is softness, so that the volume of the product can be reduced, and the design of the product with good flexibility can also be increased.

The sensing unit 20 includes a housing 24. The type of housing 24 is not limited to the optical sensing device of FIG. 3. The housing 24 is provided for fixing the signal emitter 21, the signal receiver 22 and the sensing circuit module 23 therein. The housing 24 can also be the box and the cabinet.

For the easy control to use, please refer to FIG. 1B. The liquid output sensing device 1 includes a second controller 50. The second controller 50 is disposed separated from the sensing unit 20. The second controller 50 is electrically connected with the sensing unit 20 and the first controller 13 via the liner circuit, but it would not be limited in this embodiment. Also shown in FIG. 1A, the second controller 50 is connected and is electrically connected with the sensing unit 20, and the second controller 50 is electrically connected with the first controller 14. Thus, the components of the present invention can be simplified to facilities, assembly and the installation.

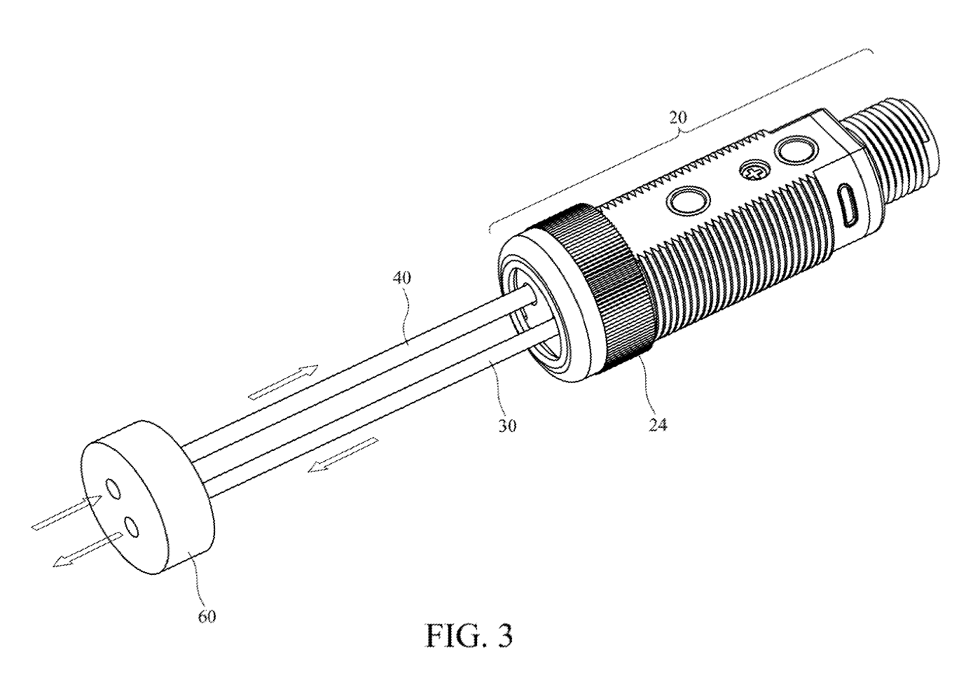

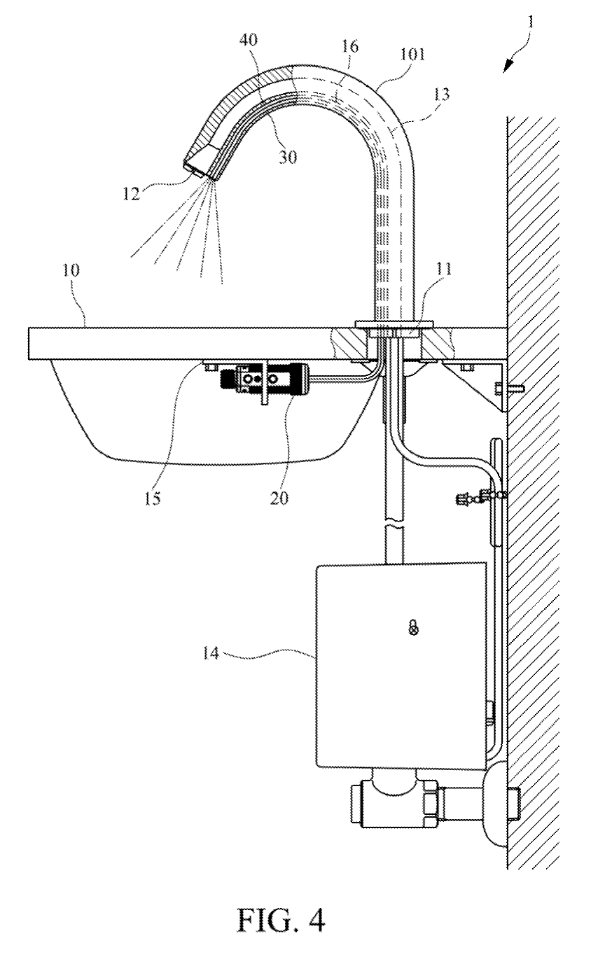

Please refer to FIG. 3 and FIG. 4. The liquid input sensing device also includes a positioning element 60 which is provided for fixing and connecting the first optical fiber 30 with the second optical fiber 40. The delivery structure 101 includes at least one passageway 16 therein, which is provided for positioning the first optical fiber 30 and the second optical fiber 50. The first optical fiber 30 and the second optical fiber 40 is fixed by a fixing element 60, and then is combined with the delivery structure 101 through the passageway 16. The first optical fiber 30 and the second optical fiber 40 are disposed adjacent to the liquid output port 12 for the sensing sensibility. In addition, the sensing unit 20 is disposed separated from the delivery structure 101 for preventing the limitation of the volume of the sensing unit 20 and influence of the design of the delivery structure 101, so that the reduction of the volume can be accomplished and the cost can be reduced. Thus, the delivery structure 101 can be the variety of the shape. On the other hand, the sensing unit 20 can be disposed at any part of the body 10 to assemble, take apart and replace to increase the convenient of use.

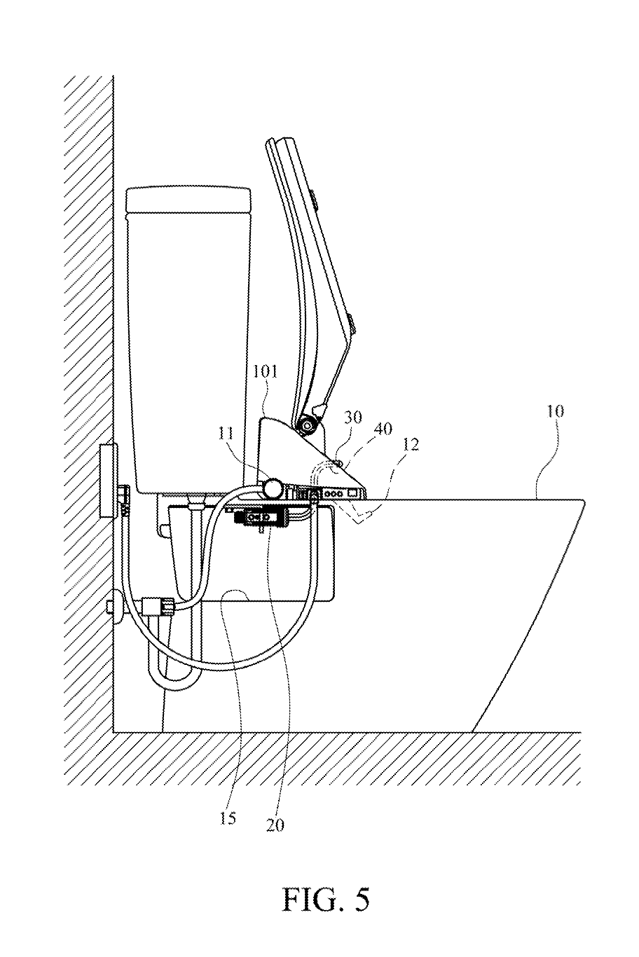

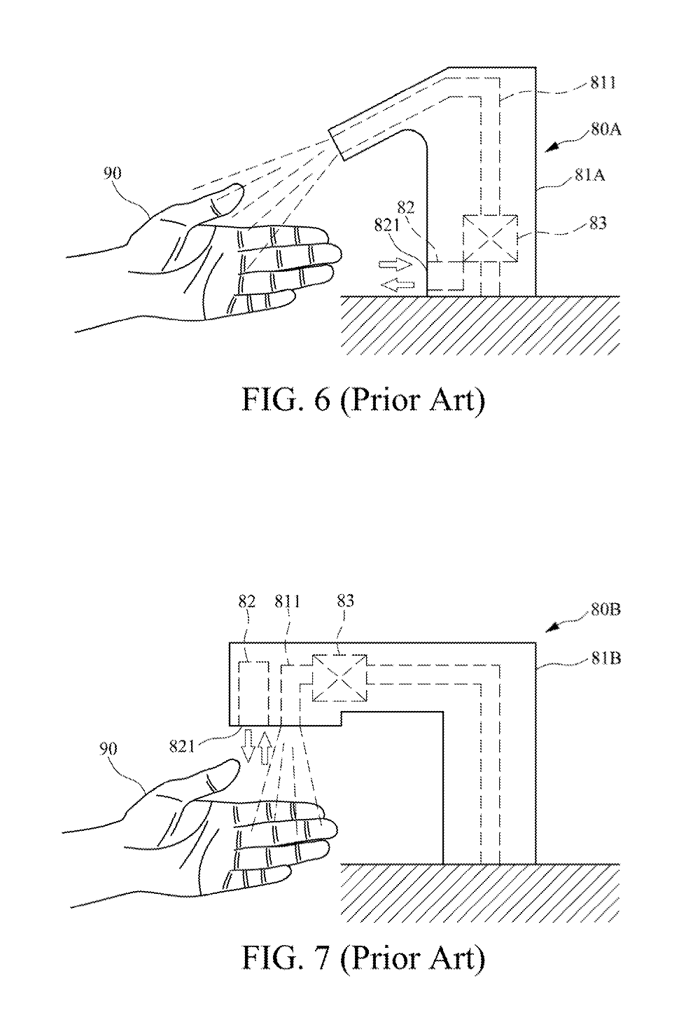

The body 10 includes a positioning element 15, which is provided for fixing the sensing unit 20. In one embodiment, the positioning element 15 can be a cavity (as shown in FIG. 5) which is provided for accommodating and connecting with the locking. The shape of the positioning element 15 can also be the L-type plate which is also provided for connecting with the locking.

The body 10 can be a washbasin (as shown in FIG. 4), a drink fountains, an automatic paper machine, an alcohol sterilizer, a humidifier, a toilet (as shown in FIG. 5), a shower column, or a sprinkler. The delivery structure 101 can be a spray structure of said faucet (as shown in FIG. 4), a spray structure of the pipeline, a spray structure of a toilet seat, an outlet structure of the drink fountains, a spray nozzle of the alcohol sterilizer, a spray structure of the humidifier, a sprinkler structure of the shower column, and a nozzle of the sprinkler.

In view of above, the liquid output sensing device 1 has been designed by the combination of the body 10, the sensing unit 20, the first optical fiber 30 and the second optical fiber 40, and is implemented with the feature of small area and the softness of the signal emitting terminal and the signal receiving terminal of the first optical fiber 30 and the second optical fiber 40, the overall volume of the product can be reduced and the design of the product with the good flexibility, so as to the cost can be reduced and the easy for assembling, taking apart and replacing to increase the convenient of use.

What is claimed is:

1. A liquid output sensing device, comprising:
a body is connected with a delivery structure, a liquid input port is disposed on one end of said delivery structure and a liquid output port is disposed on another end of said delivery structure to cause the liquid is flowed out toward a specified direction, a liquid delivery channel is disposed between said liquid input port and said liquid output port and said liquid delivery channel is connected with a first controller, said first controller is used to control said liquid flow;
a sensing unit is connected with said body, and said sensing unit is electrically connected with said first controller;
a first optical fiber, one end of said first optical fiber is connected with said sensing unit, and another end of said first optical fiber is connected with said delivery structure and is located near said liquid output port, wherein said first optical fiber emits a signal from said sensing unit to said specified direction; and
a second optical fiber, one end of said second optical fiber is connected with said delivery structure and is located near said liquid output port to receive an external signal, and another end of said second optical fiber, which is connected with said sensing unit for providing said external signal to said sensing unit.

2. The liquid output sensing device according to claim 1, wherein said sensing unit includes a signal emitter, a signal receiver, a sensing circuit module, said sensing circuit module is electrically connected with said signal emitter and said signal receiver respectively, said signal emitter is disposed on one end of said sensing unit and is electrically connected with said end of said first optical fiber, wherein said signal receiver is disposed adjacent to said signal emitter and is electrically connected with another end of said second optical fiber.

3. The liquid output sensing device according to claim 1, wherein said sensing unit includes a housing for fixing said signal emitter, said signal receiver and said sensing circuit module.

4. The liquid output sensing device according to claim 1, wherein said liquid output sensing device includes a second controller that is connected and is electrically connected with said sensing unit, and said second controller is electrically connected with said first controller.

5. The liquid output sensing device according to claim 1, wherein said liquid output sensing device includes a second controller that is electrically connected with said sensing unit and said first controller respectively.

6. The liquid output sensing device according to claim 1, wherein said liquid output sensing device further includes a fixing element for fixing said first optical fiber and said second optical fiber, and said liquid delivery channel includes at least a passageway therein for fixing said first optical fiber and said second optical fiber.

7. The liquid output sensing device according to claim 1, wherein said body includes a positioning element for fixing said sensing unit.

8. The liquid output sensing device according to claim 1, wherein said body is selected from the group consisting of a washbasin, a drink fountains, an automatic paper machine, an alcohol sterilizer, a humidifier, a toilet, a shower column, and a sprinkler.

9. The liquid output sensing device according to claim 1. wherein said delivery structure is selected from the group consisting of a spray structure of said faucet, a spray structure of said pipeline, a spray structure of a toilet seat, an outlet structure of said drink fountains, a spray nozzle of said alcohol sterilizer, a spray structure of said humidifier, a sprinkler structure of said shower column, and a nozzle of said sprinkler.
